(19) United States
(12) Patent Application Publication
(10) Pub. No.: US 2005/0052793 A1
(43) Pub. Date: Mar. 10, 2005

(54) Magnetoresistive spin-valve sensor and magnetic storage apparatus

(75) Inventors: Jongill Hong, Seoul (KR); Hitoshi Kanai, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 10/923,599

(22) Filed: Aug. 20, 2004

Related U.S. Application Data
(63) Continuation of application No. PCT/JP02/01669, filed on Feb. 25, 2002.

(51) Int. Cl. G11B 5/33; G11B 5/127

(52) U.S. Cl. 360/324.12

(57) ABSTRACT

A magnetoresistive spin-valve sensor includes a first layer made of a magnetic material, a second layer made of a magnetic or nonmagnetic material and disposed on the first layer, and a third layer made of a magnetic material and disposed on the second layer, where the first, second and third layers form a free layer having a multi-layer structure.

This application is a continuation application filed under 35 U.S.C. 111(a) claiming the benefit under 35 U.S.C. 120 and 365(c) of a PCT International Application No. PCT/JP02/01669 filed Feb. 25, 2002, in the Japanese Patent Office, the disclosure of which is hereby incorporated by reference.

The PCT International Application No. PCT/JP02/01669 was published in the English language on Aug. 28, 2003 under International Publication Number WO 03/071300 A1.

### BACKGROUND OF THE INVENTION

1. Field of the Invention

The present invention generally relates to magnetoresistive spin-valve sensors and magnetic storage apparatuses, and more particularly to a magnetoresistive spin-valve sensor having a structure for improving an output thereof, and to a magnetic storage apparatus which uses such a magnetoresistive spin-valve sensor.

2. Description of the Related Art

A typical magnetoresistive spin-valve sensor includes a base layer, a first magnetic (pinned) layer, a spacer layer, and a second magnetic (free) layer which are stacked in this order. By increasing the output of the magneto-resistive spin-valve sensor, it is possible to read information from magnetic recording media having a high recording density.

Giant magnetoresistance (GMR) of magnetoresistive spin-valve sensors is originated by combinations of interface, bulk and impurity spin-dependent scattering, as may be understood from findings in S. S. P. Parkin, “Origin of Enhanced Magnetoresistance of Magnetic Multilayers: Spin-Dependent Scattering from Magnetic Interface States”, Phys. Rev. Lett., vol. 71(10), pp.1641-1644 (1993), B. Dieny et al., “Giant magnetoresistance in soft ferromagnetic multilayers”, Phys. Rev. B., vol. 43(1), pp.1297-1300 (1991), J. Barnas et al., “Novel magnetoresistance effect in layered magnetic structures: Theory and experiment”, Phys. Rev. B., vol. 42(13), pp.8110-8120 (1990), and B. Dieny, “Classical theory of giant magnetoresistance in spin-valve multilayers: influence of thicknesses, number of periods, bulk and interfacial spin-dependent scattering”, J. Phys.: Condens. Matter, vol. 4, pp.8009-8021 (1992).

By making additional magnetic interfaces in the free layer or the pinned layer of the magnetoresistive spin-valve sensor, the magneto-resistance response can be improved. It is also known that the GMR of the magnetoresistive spin-valve sensor can be increased by decreasing the thickness of the free layer, because a magnetic flux density and thickness product, that is, a tBs value, decreases accordingly, where t denotes the thickness of the free layer and Bs denotes the magnetic flux density of the free layer.

However, when the thickness of the free layer decreases, it is difficult to maintain a small coercive field and a small interlayer coupling field between the pinned layer and the free layer. As a result, the thermal stability of the magneto-resistive spin-valve sensor deteriorates, to thereby generate noise. For this reason, there was a problem in that it is difficult to improve the thermal stability while suppressing the generation of noise.

### SUMMARY OF THE INVENTION

Accordingly, it is a general object of the present invention to provide a novel and useful magnetoresistive spin-valve sensor and magnetic storage apparatus, in which the problem described above are eliminated.

Another and more specific object of the present invention is to provide a magnetoresistive spin-valve sensor comprising a first layer made of a magnetic material, a second layer made of a magnetic material and disposed on the first layer, and a third layer made of a magnetic material and disposed on the second layer, where the first, second and third layers form a free layer having a multi-layer structure. According to the magnetoresistive spin-valve sensor of the present invention, it is possible to improve both the MR response and the thermal stability while suppressing the generation of noise.

Still another object of the present invention is to provide a magnetoresistive spin-valve sensor comprising a first layer made of a magnetic material, a second layer made of a nonmagnetic material and disposed on the first layer, and a third layer made of a magnetic material and disposed on the second layer, where the first, second and third layers form a free layer having a multi-layer structure. According to the magneto-resistive spin-valve sensor of the present invention, it is possible to improve both the MR response and the thermal stability while suppressing the generation of noise.

A further object of the present invention is to provide a magnetoresistive spin-valve sensor comprising a magnetic layer made of a magnetic layer forming a free layer, a first specular layer disposed on the magnetic layer, a first protection layer disposed on the first specular layer, a second specular layer disposed on the first protection layer, and a second protection layer disposed on the second specular layer. According to the magnetoresistive spin-valve sensor of the present invention, it is possible to improve both the MR response and the thermal stability while suppressing the generation of noise.

Another object of the present invention is to provide a magnetoresistive spin-valve sensor comprising a spacer layer made of a metal material, a magnetic layer disposed on the spacer layer and made of an amorphous material forming a free layer, and a specular layer disposed on the magnetic layer. According to the magnetoresistive spin-valve sensor of the present invention, it is possible to improve both the MR response and the thermal stability while suppressing the generation of noise.

Still another object of the present invention is to provide a magnetic storage apparatus for reading information from a magnetic recording medium, comprising a magnetoresistive spin-valve sensor which reads the information from the magnetic recording medium, where the magnetoresistive spin-valve sensor comprises a first layer made of a magnetic material, a second layer made of a magnetic or nonmagnetic material and disposed on the first layer, and a third layer made of a magnetic material and disposed on the second layer, and the first, second and third layers form a free layer having a multi-layer structure. According to the magnetic storage apparatus of the present invention, it is possible to improve both the MR response and the thermal stability while suppressing the generation of noise.

A further object of the present invention is to provide a magnetic storage apparatus for reading information from a magnetic recording medium, comprising a magnetoresistive spin-valve sensor which reads the information from the magnetic recording medium, where the magnetoresistive spin-valve sensor comprises a magnetic layer made of a magnetic material forming a free layer, a first specular layer disposed on the magnetic layer, a first protection layer disposed on the first specular layer, a second specular layer disposed on the first protection layer, and a second protection layer disposed on the second specular layer. According to the magnetic storage apparatus of the present invention, it is possible to improve both the MR response and the thermal stability while suppressing the generation of noise.

Another object of the present invention is to provide a magnetic storage apparatus for reading information from a magnetic recording medium, comprising a magnetoresistive spin-valve sensor which reads the information from the magnetic recording medium, where the magnetoresistive spin-valve sensor comprises a spacer layer made of a metal material, a magnetic layer disposed on the spacer layer and made of an amorphous material forming a free layer, and a specular layer disposed on the magnetic layer. According to the magnetic storage apparatus of the present invention, it is possible to improve both the MR response and the thermal stability while suppressing the generation of noise.

Other objects and further features of the present invention will be apparent from the following detailed description when read in conjunction with the accompanying drawings.

### BRIEF DESCRIPTION OF THE DRAWINGS

FIG. 1 is a cross sectional view showing an important part of a first embodiment of a magnetoresistive spin-valve sensor according to the present invention;

FIG. 2 is a cross sectional view showing a multi-layer structure of a second magnetic layer;

FIG. 3 is a cross sectional view showing another multi-layer structure of the second magnetic layer;

FIG. 4 is a diagram showing a sheet resistance of the second magnetic layer having the multi-layer structure;

FIG. 5 is a diagram showing an interlayer coupling field between a first magnetic layer and the second magnetic layer;

FIG. 6 is a diagram showing the sheet resistance for a magnetoresistive spin-valve sensor having a free layer with a single-layer structure;

FIG. 7 is a diagram showing the sheet resistance of the second magnetic layer having the multi-layer structure;

FIG. 8 is a diagram showing the interlayer coupling field between the first magnetic layer and the second magnetic layer;

FIG. 9 is a cross sectional view showing an important part of a second embodiment of the magnetoresistive spin-valve sensor according to the present invention;

FIG. 10 is a diagram showing the sheet resistances of the second embodiment of the magnetoresistive spin-valve sensor and magnetoresistive spin-valve sensors having free layers with a single-layer structure and a double-layer structure;

FIG. 11 is a diagram showing the interlayer coupling fields of the second embodiment of the magnetoresistive spin-valve sensor and the magnetoresistive spin-valve sensors having the free layers with the single-layer structure and the double-layer structure;

FIG. 12 is a diagram showing the coercivities of the second embodiment of the magnetoresistive spin-valve sensor and the magnetoresistive spin-valve sensors having the free layers with the single-layer structure and the double-layer structure;

FIG. 13 is a diagram showing interlayer coupling fields between an antiferromagnetic layer and a pinned layer of the second embodiment of the magnetoresistive spin-valve sensor and the magnetoresistive spin-valve sensors having the free layers with the single-layer structure and the double-layer structure;

FIG. 14 is a diagram showing magnetic flux density and thickness products of the second embodiment of the magnetoresistive spin-valve sensor and the magnetoresistive spin-valve sensors having the free layers with the single-layer structure and the double-layer structure;

FIG. 15 is a cross sectional view showing an important part of a third embodiment of the magnetoresistive spin-valve sensor according to the present invention;

FIG. 16 is a diagram showing minor loop properties of magnetoresistive spin-valve sensors having a single specular capping and a double specular capping;

FIG. 17 is a cross sectional view showing an important part of a fourth embodiment of the magnetoresistive spin-valve sensor according to the present invention;

FIG. 18 is a diagram showing simulation results of a sensor output obtained by the fourth embodiment of the magnetoresistive spin-valve sensor;

FIG. 19 is a cross sectional view showing an important part of an embodiment of a magnetic storage apparatus according to the present invention; and

FIG. 20 is a plan view showing the important part of the embodiment of the magnetic storage apparatus.

### DESCRIPTION OF THE PREFERRED EMBODIMENTS

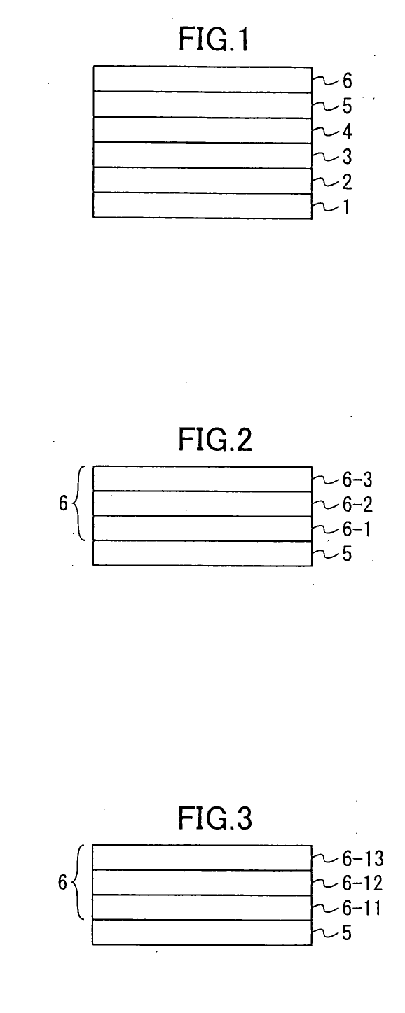

A description will be given of a first embodiment of a magnetoresistive spin-valve sensor according to the present invention, by referring to FIG. 1. FIG. 1 is a cross sectional view showing an important part of this first embodiment of the magnetoresistive spin-valve sensor according to the present invention. The magnetoresistive spin-valve sensor shown in FIG. 1 includes a substrate 1, an underlayer 2, an antiferromagnetic layer 3, a first magnetic layer 4, a spacer layer 5, and a second magnetic layer 6.

For example, the underlayer 2 has a multi-layer structure including a Ta layer and a NiFe layer formed on the Ta layer. Further, the antiferromagnetic layer 3 is made of PdPtMn, for example, and forms a pinning layer.

The first magnetic layer 4 is made of a magnetic material such as a Co alloy, and may have a single-layer structure or, a multi-layer structure as in the case of the second magnetic layer 6 which will be described later. The first magnetic layer 4 forms a pinned layer of the magnetoresistive spin-valve sensor. The spacer layer 5 is made of a nonmagnetic metal such as Cu.

The second magnetic layer 6 has a multi-layer structure shown in FIG. 2 or FIG. 3, and forms a free layer of the magnetoresistive spin-valve sensor.

The second magnetic layer 6 shown in FIG. 2 is made up of a first layer 6-1, a second layer 6-2, and a third layer 6-3. Each of the first, second and third layers 6-1, 6-2 and 6-3 is made of a material selected from a group consisting of Ni, Co, Fe, B, CoFe, CoFeB, NiFe, alloys thereof, and oxides thereof. In addition, each of the first, second and third layers 6-1, 6-2 and 6-3 has a thickness greater than 0 and less that 20 Angstroms. In a first modification, the multi-layer structure shown in FIG. 2 is provided periodically, that is, repeated a plurality of times on the spacer layer 5.

On the other hand, the second magnetic layer 6 shown in FIG. 3 is made up of a first layer 6-11, a second layer 6-12, and a third layer 6-13. Each of the first and third layers 6-11 and 6-13 is made of a material selected from a group consisting of Ni, Co, Fe, B, CoFe, CoFeB, NiFe, alloys thereof, and oxides thereof. In addition, each of the first and third layers 6-11 and 6-13 has a thickness greater than 0 and less that 20 Angstroms. Furthermore, the second layer 6-12 is made of a nonmagnetic material selected from a group consisting of B, Ta, Ru, Ni, Fe, Pd, Pt, Mn, Cu, Co, Ti, C, Cr, Zn, Y, Zr, Nb, Mo, Rh, Ag, Au, Hf, W, Re, Os, Ir, Nb, alloys thereof, and oxides thereof. The second layer 6-12 has a thickness greater than 0 and less than 20 Angstroms. In a second modification, the multi-layer structure shown in FIG. 3 is provided periodically, that is, repeated a plurality of times on the spacer layer 5.

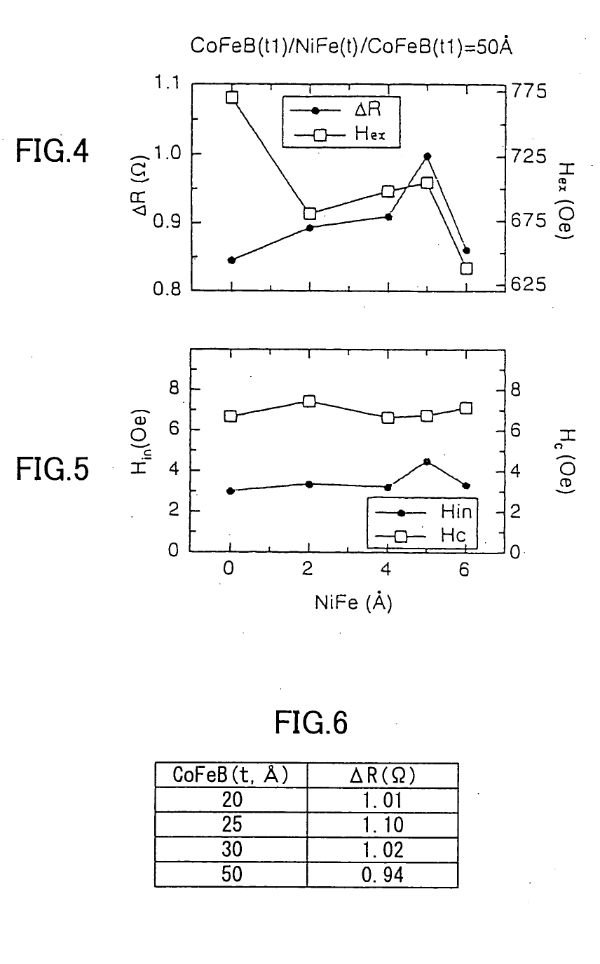

FIG. 4 is a diagram showing a sheet resistance ΔR of the second magnetic layer 6 having the multi-layer structure, and FIG. 5 is a diagram showing an interlayer coupling field Hᵢₙ between the first magnetic layer 4 and the second magnetic layer 6, for a case where the first layer 6-1 is made of CoFeB having a thickness t1, the second layer 6-2 is made of NiFe having a thickness t, and the third layer 6-3 having a thickness t1, where t1+t+t1=50 Angstroms.

In FIG. 4, the left ordinate indicates the sheet resistance ΔR, the right ordinate indicates an interlayer coupling field Hex between the antiferromagnetic layer 3 and the first magnetic layer 4, and the abscissa indicates the thickness t of the second layer 6-2. In addition, a symbol “●” indicates the sheet resistance ΔR, and a symbol “□” indicates the interlayer coupling field Hₑₓ.

In FIG. 5, the left ordinate indicates the interlayer coupling field Hᵢₙ between the first magnetic layer 4 and the second magnetic layer 6, the right ordinate indicates a coercivity H_{c} of the second magnetic layer 6, and the abscissa indicates the thickness t of the second layer 6-2. In addition, a symbol “•” indicates the interlayer coupling field Hᵢₙ, and a symbol “□” indicates the coercivity H_{c}.

For this particular case, it may be seen from FIGS. 4 and 5 that an optimum sheet resistance ΔR is found when t=22.5 Angstroms and t1=5 Angstroms.

For comparison purposes, FIG. 6 shows the sheet resistance ΔR for a magnetoresistive spin-valve sensor having a free layer with a single-layer structure. This magnetoresistive spin-valve sensor used for comparison purposes includes a 50 Angstroms thick Ta layer and a 20 Angstroms thick NiFe layer which form an underlayer, a 150 Angstroms thick PdPtMn layer which forms an antiferromagnetic layer, a 15 Angstroms thick CoFeB layer, a 7.5 Angstroms thick Ru layer and a 25 Angstroms thick CoFeB layer which form a pinned layer, a 30 Angstroms thick Cu layer which forms a spacer layer, a t Angstroms thick CoFeB free layer, and a 50 Angstroms thick Ta layer which forms a capping layer.

It may be seen by comparing FIGS. 4 and 5 with FIG. 6 that the sheet resistance ΔR is improved from 0.87 Ohms to 1.00 Ohms according to this embodiment. In other words, although the sheet resistance ΔR generally increases as the thickness of the free layer decreases in the case of the free layer having the single-layer structure, substantially the opposite is observed for this embodiment employing the free layer having the multi-layer structure, that is, the second magnetic layer 6 having the first, second and third layers 6-1, 6-2 and 6-3.

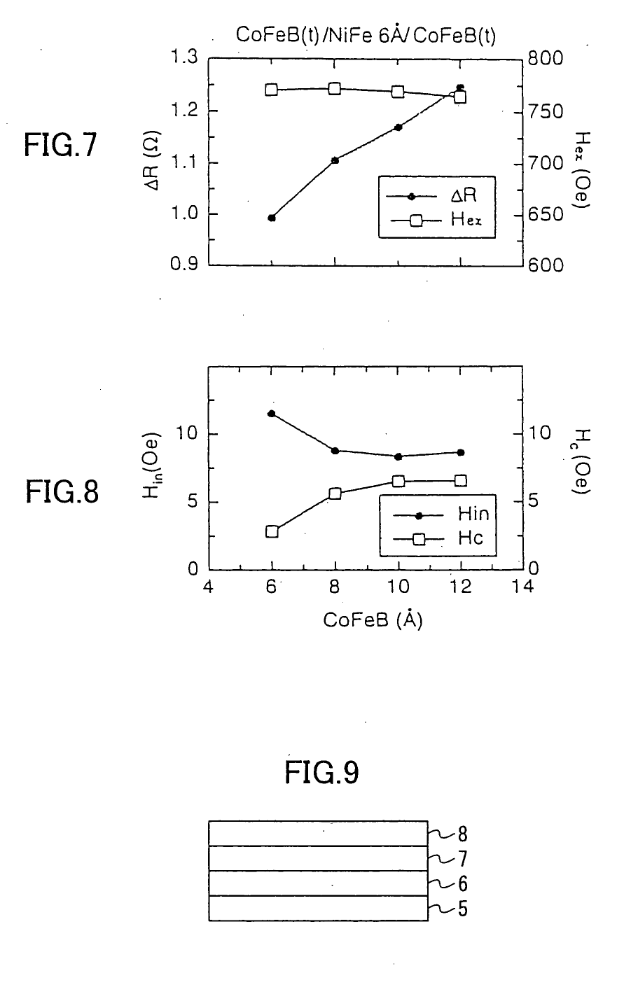

FIG. 7 is a diagram showing the sheet resistance ΔR of the second magnetic layer 6 having the multi-layer structure, and FIG. 8 is a diagram showing the interlayer coupling field Hᵢₙ between the first magnetic layer 4 and the second magnetic layer 6, for a case where the first layer 6-1 is made of CoFeB having a thickness t, the second layer 6-2 is made of NiFe having a thickness of 60 Angstroms, and the third layer 6-3 having a thickness t.

In FIG. 7, the left ordinate indicates the sheet resistance ΔR, the right ordinate indicates the interlayer coupling field Hₑₓ, and the abscissa indicates the thickness t of the first and third layers 6-1 and 6-3. In addition, a symbol “●” indicates the sheet resistance ΔR, and a symbol “□” indicates the interlayer coupling field Hₑₓ.

In FIG. 8, the left ordinate indicates the interlayer coupling field Hᵢₙ, the right ordinate indicates the coercivity H_{c} of the second magnetic layer 6, and the abscissa indicates the thickness t of the first and third layers 6-1 and 6-3. In addition, a symbol “●” indicates the interlayer coupling field Hᵢₙ, and a symbol “□” indicates the coercivity H_{c}.

It may be seen by comparing FIGS. 7 and 8 with FIG. 6 that the sheet resistance ΔR is improved from 0.94 Ohms to 1.25 Ohms according to this embodiment for t=12 Angstroms, that is, for the second magnetic layer 6 having a total thickness of 30 Angstroms.

Next, a description will be given of a second embodiment of the magnetoresistive spin-valve sensor according to the present invention, by referring to FIG. 9. FIG. 9 is a cross sectional view showing an important part of this second embodiment of the magnetoresistive spin-valve sensor according to the present invention. In FIG. 9, those parts which are the same as those corresponding parts in FIG. 1 are designated by the same reference numerals, and a description thereof will be omitted. The magnetoresistive spin-valve sensor shown in FIG. 9 additionally includes a specular layer 7, and a metal capping layer 8. The second magnetic layer 6 may have the multi-layer structure shown in FIG. 2 or FIG. 3.

The specular layer 7 is made of a material selected from a group consisting of CoO, Co₃O₄, Co₂O₃, Cu₂O, CuO, Al₂O₃, NiO, FeO, Fe₂O₃, Fe₃O₄, MnO, TiO₂, SiO₂, and alloys thereof. The specular layer 7 has a thickness greater than 0 and less than 30 Angstroms. The metal capping layer 8 is made of Cu, for example, and forms a protection layer of the magnetoresistive spin-valve sensor.

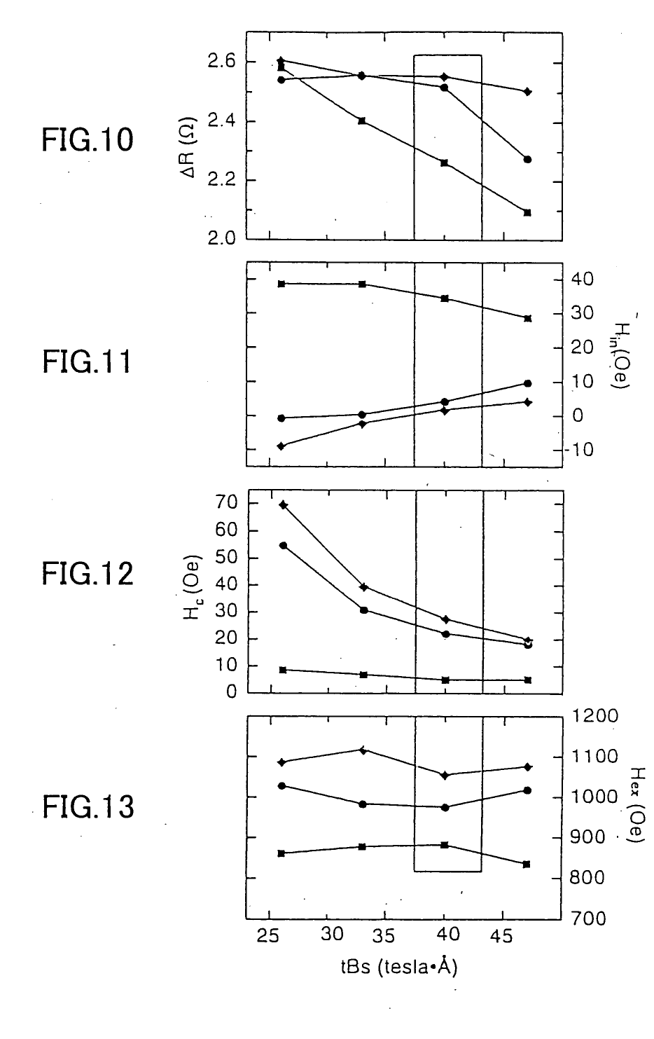

FIG. 10 is a diagram showing the sheet resistances ΔR of the second embodiment of the magnetoresistive spin-valve sensor and magneto-resistive spin-valve sensors having free layers with a single-layer structure and a double-layer structure. In FIG. 10, the ordinate indicates the sheet resistance ΔR, and the abscissa indicates the magnetic flux density and thickness product tBₛ, where t denotes the thickness of the second magnetic layer 6 (that is, the free layer), and Bₛ denotes the magnetic flux density of the second magnetic layer 6 (that is, the free layer).

FIG. 11 is a diagram showing the interlayer coupling fields Hᵢₙ of the second embodiment of the magnetoresistive spin-valve sensor and the magnetoresistive spin-valve sensors having the free layers with the single-layer structure and the double-layer structure. In FIG. 11, the ordinate indicates the interlayer coupling field Hᵢₙ between the first and second magnetic layers 4 and 6 (that is, the pinned layer and the free layer), and the abscissa indicates the magnetic flux density and thickness product tBₛ.

FIG. 12 is a diagram showing the coercivities H_{c} of the second embodiment of the magnetoresistive spin-valve sensor and the magneto-resistive spin-valve sensors having the free layers with the single-layer structure and the double-layer structure. In FIG. 12, the ordinate indicates the coercivity H_{c} and the abscissa indicates the magnetic flux density and thickness product tBₛ.

FIG. 13 is a diagram showing the interlayer coupling fields Hₑₓ of the second embodiment of the magnetoresistive spin-valve sensor and the magnetoresistive spin-valve sensors having the free layers with the single-layer structure and the double-layer structure. In FIG. 13, the ordinate indicates the interlayer coupling field Hₑₓ, and the abscissa indicates the magnetic flux density and thickness product tBₛ.

In FIGS. 10 through 13, a symbol “●” indicates the characteristic of the second magnetic layer 6 of this second embodiment having the multi-layer structure formed by a CoFe first layer, a NiFe second layer, and a CoFe third layer. A symbol “▪” indicates the characteristic of the free layer having the double-layer structure formed by a CoFe layer and a NiFe layer, and a symbol “♦” indicates the characteristic of the free layer having the single-layer structure formed by a CoFe layer. For each of the magnetoresistive spin-valve sensors, it is assumed for the sake of convenience that a 50 Angstroms thick Ta layer and a 16 Angstroms thick NiFe layer form the underlayer 2, a 150 Angstroms thick PdPtMn layer forms the antiferromagnetic layer 3, a 15 Angstroms thick CoFe layer, a 9.5 Angstroms thick Ru layer and a 10 Angstroms thick CoFeB layer form the first magnetic layer (pinned layer) 4, a 20 Angstroms thick Cu layer which forms the spacer layer 5, a 7 Angstroms thick Cu layer which forms the specular layer 7, and a 30 Angstroms thick CoO layer which forms the capping layer 8.

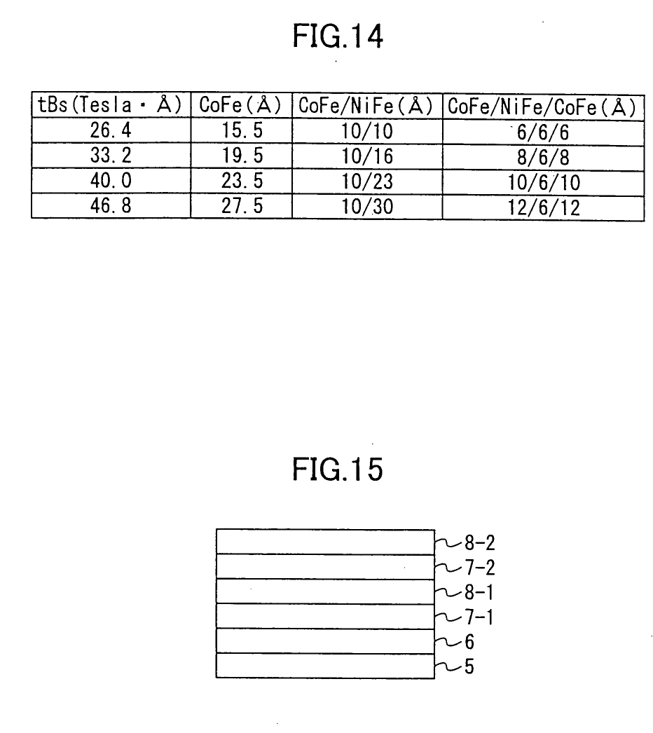

FIG. 14 is a diagram showing a magnetic flux density and thickness products tBₛ of the second embodiment of the magnetoresistive spin-valve sensor and the magnetoresistive spin-valve sensors having the free layers with the single-layer structure and the double-layer structure. In other words, FIG. 14 shows the corresponding thicknesses of each of the layers forming the free layers having the multi-layer (triple-layer) structure, the double-layer structure and the single-layer structure with respect to the tBₛ values.

It may be seen from FIG. 10 that the sheet resistance ΔR of this second embodiment does not decrease to as small value as the thickness of the second magnetic layer 6 (free layer) decreases, when compared to the magnetoresistive spin-valve sensor having the free layer with the double-layer structure. It may be seen from FIGS. 11 and 12 that the interlayer coupling field Hᵢₙ and the coercivity H_{c} of this second embodiment respectively are higher than those of the magnetoresistive spin-valve sensor having the free layer with the single-layer structure. In addition, it may be seen from FIG. 13 that the interlayer coupling field Hₑₓ of this second embodiment is higher than that of the magneto-resistive spin-valve sensor having the free layer with the double-layer structure. Therefore, it was confirmed that the second magnetic layer 6 (free layer) having the multi-layer structure (triple-layer structure) is suited for use in the magnetoresistive spin-valve sensor to utilize the soft magnetic properties thereof.

Next, a description will be given of a third embodiment of the magnetoresistive spin-valve sensor according to the present invention, by referring to FIG. 15. FIG. 15 is a cross sectional view showing an important part of this third embodiment of the magnetoresistive spin-valve sensor. In FIG. 15, those parts which are the same as those corresponding parts in FIG. 1 are designated by the same reference numerals, and a description thereof will be omitted. The magnetoresistive spin-valve sensor shown in FIG. 15 includes a first specular layer 7-1, a first protection layer 8-1, a second specular layer 7-2, and a second protection layer 8-2 which are disposed in this order on the second magnetic layer 6. The second magnetic layer 6 may have a single-layer structure, a double-layer structure, or the multi-layer (triple-layer) structure shown in FIG. 2 or FIG. 3.

Each of the first and second specular layers 7-1 and 7-2 is made of a material selected from a group consisting of CoO, Co₃O₄, Co₂O₃, Cu₂O, CuO, Al₂O₃, NiO, FeO, Fe₂O₃, Fe₃O₄, MnO, TiO₂, SiO₂, and alloys thereof. For example, the first specular layer 7-1 has a thickness greater than 0 and less than 30 Angstroms, and the second specular layer 7-2 has a thickness greater than 0 and less than 30 Angstroms.

Each of the first and second protection layers 18-1 and 18-2 is made of a material selected from a group consisting of B, Ta, Ru, Ni, Fe, Pd, Pt, Mn, Cu, Co, Ti, C, Cr, Zn, Y, Zr, Nb, Mo, Rh, Ag, Au, Hf, W, Re, Os, Ir, Nb, alloys thereof, and oxides thereof. For example, the first protection layer 8-1 has a thickness greater than 0 and less than 20 Angstroms, and the second protection layer 8-2 has a thickness greater than 0 and less than 200 Angstroms.

It is known from W. F. Egelhoff, Jr. et al., “Specular electron scattering in metallic thin films”, J. Vac. Sci. Technol. B, Vol.17(4), pp.1702-1707 (1999) that an oxide capping layer in a magnetoresistive spin-valve sensor enhances the MR response. However, the conventional oxide capping layer has a low specularity at an interface between the oxide capping layer and the magnetic layer. Furthermore, the magnetoresistive spin-valve sensor having the conventional oxide capping layer has hard magnetic properties, such as a large coercivity and a large interlayer coupling fields.

This embodiment further enhances the MR response by employing the double specular capping. The first specular layer 7-1 has pin holes or, is thin and continuous. The second specular layer 7-2 and the second protection layer 8-2 may be replaced by a single thick specular capping layer which is made of Al₂O₃, for example, and serves as a gap of the magnetoresistive spin-valve sensor. This single thick specular capping layer may be made of a material selected from a group consisting of CoO, Co₃O₄, Co₂O₃, Cu₂O, CuO, Al₂O₃, NiO, FeO, Fe₂O₃, Fe₃O₄, MnO, TiO₂, SiO₂, B, Ta, Ru, Ni, Fe, Pd, Pt, Mn, Cu, Co, Ti, C, Cr, Zn, Y, Zr, Nb, Mo, Rh, Ag, Au, Hf, W, Re, Os, Ir, Nb, alloys thereof, and oxides thereof, and have a thickness greater than 0 and less than 200 Angstroms, for example. When oxides are used for the first and second specular layers 7-1 and 7-2, it was confirmed that the double specular capping enhances the MR response by approximately 20% compared to the single specular capping, as may be seen from FIG. 16. It may be regarded that the enhanced MR response is caused by electrons which pass or penetrate through the thin first specular layer 7-1 and are reflected by the second protection layer 8-2 (or the single specular capping layer) and then returned to the core of the magnetoresistive spin-valve sensor where the GMR occurs, to thereby generate a large GMR.

FIG. 16 is a diagram showing minor loop properties of magnetoresistive spin-valve sensors having the single specular capping and the magnetoresistive spin-valve sensors having the double specular capping as in the case of this embodiment. More particularly, FIG. 16 shows the GMR, the sheet resistance ΔR, the resistance R, the interlayer coupling field Hᵢₙ, and the free layer structure for cases C1, C2, C3 and C4. In the “free layer structure” row, CoFe8/NiFe6/CoFe15 indicates that the free layer (second magnetic layer 6) is made up of an 8 Angstroms thick CoFe first layer, 6 Angstroms thick NiFe second layer, and a 15 Angstroms thick CoFe third layer. Similarly, CoFe8/NiFe6/CoFe10 indicates that the free layer (second magnetic layer 6) is made up of an 8 Angstroms thick CoFe first layer, 6 Angstroms thick NiFe second layer, and a 10 Angstroms thick CoFe third layer. Further, CoFe10/NiFe18 indicates that the free layer (second magnetic layer 6) is made up of a 10 Angstroms thick CoFe layer and an 18 Angstroms thick NiFe layer.

In the case C1, a thin oxide layer is provided as the first specular layer 7-1 on the CoFe8/NiFe6/CoFe15 free layer (second magnetic layer 6), a Cu layer is provided as the first protection layer 8-1, and a Al₂O₃ layer is provided as the single specular capping layer which replaces the second specular layer 7-2 and the second protection layer 8-2. In the case C2, a thin oxide layer is provided as the first specular layer 7-1 on the CoFe8/NiFe6/CoFe15 free layer (second magnetic layer 6), a Cu layer is provided as the first protection layer 8-1, and a Ta layer is provided as the single specular capping layer which replaces the second specular layer 7-2 and the second protection layer 8-2. Hence, the double specular capping of this embodiment is employed in the cases C1 and C2.

On the other hand, in the case C3, a Cu layer is provided as the first specular layer 7-1 on the CoFe8/NiFe6/CoFe10 free layer (second magnetic layer 6), and a Al₂O₃ layer is provided as the first capping layer 8-1. In addition, in the case C4, a Cu layer is provided as the first specular layer 7-1 on the CoFe10/NiFe18 free layer (second magnetic layer 6), and a Ta layer is provided as the first capping layer 8-1. Hence, the single specular capping of this embodiment is employed in the cases C3 and C4, and the second specular layer 7-2 and the second protection layer 8-2 or the single specular capping layer are not provided in these cases C3 and C4.

It may be seen from FIG. 16 that large GMRs can be obtained in the cases C1 and C2 according to this embodiment as compared to the cases C3 and C4.

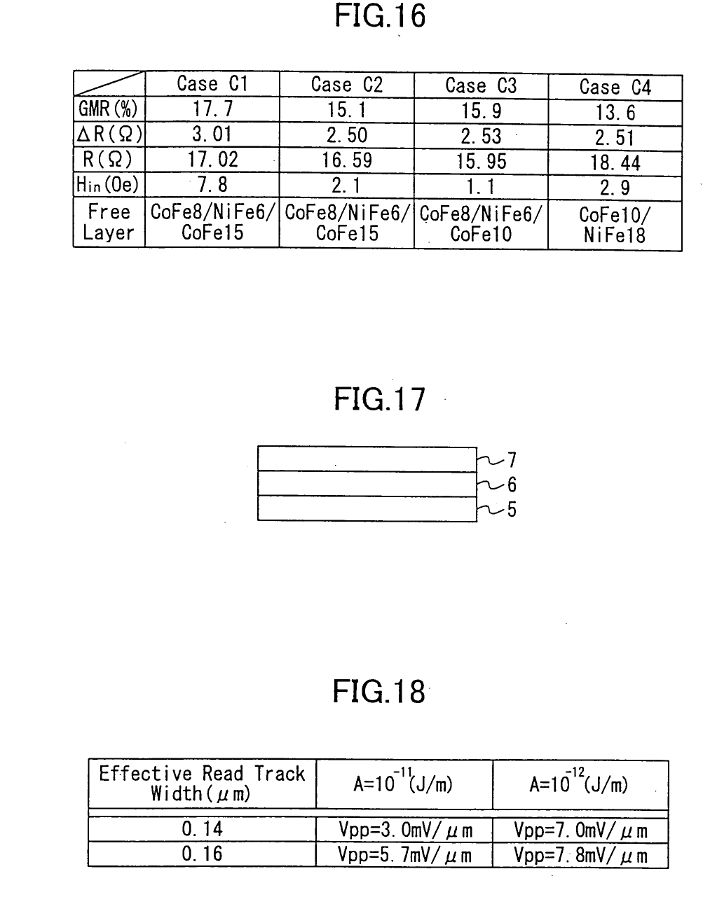

Next, a description will be given of a fourth embodiment of the magnetoresistive spin-valve sensor according to the present invention, by referring to FIG. 17. FIG. 17 is a cross sectional view showing an important part of this fourth embodiment of the magnetoresistive spin-valve sensor. In FIG. 17, those parts which are the same as those corresponding parts in FIG. 1 are designated by the same reference numerals, and a description thereof will be omitted. The magnetoresistive spin-valve sensor shown in FIG. 17 includes a second magnetic layer 6 which is made of an amorphous material and has a thickness greater than 0 and less than 50 Angstroms, and the specular layer 7 which is provided on the second magnetic layer 6. The amorphous material is selected from a group consisting of CoO, Co₃O₄, Co₂O₃, Cu₂O, CuO, Al₂O₃, NiO, FeO, Fe₂O₃, Fe₃O₄, MnO, TiO₂, SiO₂, B, Ta, Ru, Ni, Fe, Pd, Pt, Mn, Cu, Co, Ti, C, Cr, Zn, Y, Zr, Nb, Mo, Rh, Ag, Au, Hf, W, Re, Os, Ir, Nb, Si, Sn, V, W, alloys thereof, and oxides thereof.

FIG. 18 is a diagram showing a simulation result of a sensor output obtained by this embodiment. The sensor output of the magneto-resistive spin-valve sensor shown in FIG. 18 was obtained when an exchange stiffness A of spins in the second magnetic layer 6 was decreased by a tenth, while other parameters remained fixed. As may be seen from FIG. 18, it was confirmed that the sensor output increases as the exchange stiffness A decreases, and that the exchange stiffness A is decreased by the amorphous state of the second magnetic layer 6 and the provision of the specular layer 7 on this second magnetic layer 6. The small exchange stiffness A makes the sensor output relatively larger as an effective read track width decreases. As well known, a high recording density requires a small read track width.

Therefore, although an amorphous free layer in a conventional magnetoresistive spin-valve sensor would lead to poorer MR performance when compared to the conventional magnetoresistive spin-valve sensor using a crystalline free layer, this embodiment can considerably improve the MR performance even when the amorphous free layer is used, due to the provision of the specular layer on the amorphous free layer.

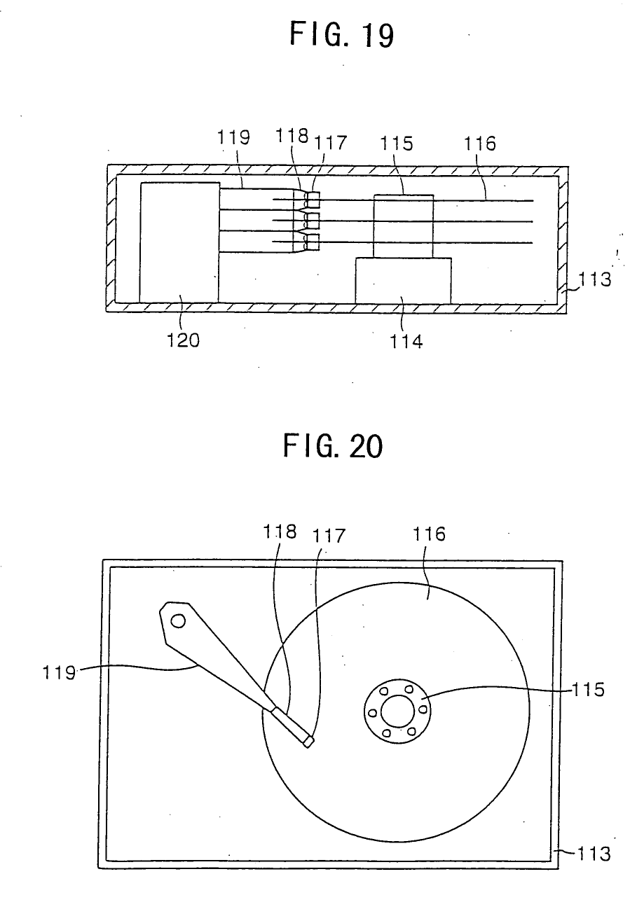

Next, a description will be given of an embodiment of a magnetic storage apparatus according to the present invention, by referring to FIGS. 19 and 20. FIG. 19 is a cross sectional view showing an important part of this embodiment of a magnetic storage apparatus according to the present invention, and FIG. 20 is a plan view showing the important part of this embodiment of the magnetic storage apparatus.

As shown in FIGS. 19 and 20, the magnetic storage apparatus generally includes a housing 113. A motor 114, a hub 115, a plurality of magnetic recording media 116, a plurality of recording and reproducing heads 117, a plurality of suspensions 118, a plurality of arms 119, and an actuator unit 120 are provided within the housing 113. The magnetic recording media 116 are mounted on the hub 115 which is rotated by the motor 114. The recording and reproducing head 117 is made up of a reproducing head and a recording head such as an inductive head. Each recording and reproducing head 117 is mounted on the tip end of a corresponding arm 119 via the suspension 118. The arms 119 are moved by the actuator unit 120. The basic construction of this magnetic storage apparatus is known, and a detailed description thereof will be omitted in this specification.

This embodiment of the magnetic storage apparatus is characterized by the reproducing head of the recording and reproducing head 117. The reproducing head has the structure of any of the first through fourth embodiments of the magneto-resistive spin-valve sensor described above in conjunction with FIGS. 1 through 18. Of course, the number of magnetic recording media 116 is not limited to three, and only one, two or four or more magnetic recording media 116 may be provided. Consequently, one of a plurality of magnetoresistive spin-valve sensors may be provided depending on the number of recording and reproducing heads 117 provided.

The basic construction of the magnetic storage apparatus is not limited to that shown in FIGS. 19 and 20. In addition, the magnetic recording medium used in the present invention is not limited to the magnetic disk.

Further, the present invention is not limited to these embodiments, but various variations and modifications may be made without departing from the scope of the present invention.

1. A magnetoresistive spin-valve sensor comprising:
a first layer made of a magnetic material;
a second layer made of a magnetic material and disposed on said first layer; and
a third layer made of a magnetic material and disposed on said second layer,
said first, second and third layers forming a free layer having a multi-layer structure.

2. A magnetoresistive spin-valve sensor comprising:
a first layer made of a magnetic material;
a second layer made of a nonmagnetic material and disposed on said first layer; and
a third layer made of a magnetic material and disposed on said second layer,
said first, second and third layers forming a free layer having a multi-layer structure.

3. The magnetoresistive spin-valve sensor as claimed in claim 1, further comprising:
a specular layer disposed on said third layer.

4. The magnetoresistive spin-valve sensor as claimed in claim 3, wherein each of said first, second and third layers is made of an amorphous material.

5. The magnetoresistive spin-valve sensor as claimed in claim 2, further comprising:
a specular layer disposed on said third layer.

6. The magnetoresistive spin-valve sensor as claimed in claim 5, wherein each of said first and third layers is made of an amorphous material.

7. The magnetoresistive spin-valve sensor as claimed in claim 4, wherein said amorphous material is selected from a group consisting of CoO, Co₃O₄, Co₂O₃, Cu₂O, CuO, Al₂O₃, NiO, FeO, Fe₂O₃, Fe₃O₄, MnO, TiO₂, SiO₂, B, Ta, Ru, Ni, Fe, Pd, Pt, Mn, Cu, Co, Ti, C, Cr, Zn, Y, Zr, Nb, Mo, Rh, Ag, Au, Hf, W, Re, Os, Ir, Nb, Si, Sn, V, W, alloys thereof, and oxides thereof.

8. The magnetoresistive spin-valve sensor as claimed in claim 4, wherein said multi-layer structure has a thickness greater than 0 and less that 50 Angstroms.

9. The magnetoresistive spin-valve sensor as claimed in claim 1, wherein each of said first, second and third layers is made of a material selected from a group consisting of Ni, Co, Fe, B, CoFe, CoFeB, NiFe, alloys thereof, and oxides thereof.

10. The magnetoresistive spin-valve sensor as claimed in claim 9, wherein each of said first, second and third layers has a thickness greater than 0 and less that 20 Angstroms.

11. The magnetoresistive spin-valve sensor as claimed in claim 2, wherein said nonmagnetic material is selected from a group consisting of B, Ta, Ru, Ni, Fe, Pd, Pt, Mn, Cu, Co, Ti, C, Cr, Zn, Y, Zr, Nb, Mo, Rh, Ag, Au, Hf, W, Re, Os, Ir, Nb, alloys thereof, and oxides thereof.

12. The magnetoresistive spin-valve sensor as claimed in claim 11, wherein said second layer has a thickness greater than 0 and less than 20 Angstroms.

13. The magnetoresistive spin-valve sensor as claimed in claim 3 or 5, wherein said specular layer is made of a material selected from a group consisting of CoO, Co₃O₄, Co₂O₃, Cu₂O, CuO, Al₂O₃, NiO, FeO, Fe₂O₃, Fe₃O₄, MnO, TiO₂, SiO₂, and alloys thereof.

14. The magnetoresistive spin-valve sensor as claimed in claim 13, wherein said specular layer has a thickness greater than 0 and less than 30 Angstroms.

15. The magnetoresistive spin-valve sensor as claimed in claim 1 or 2, further comprising:
a first specular layer disposed on said third layer;
a first protection layer disposed on said first specular layer;
a second specular layer disposed on said first protection layer; and
a second protection layer disposed on said second specular layer.

16. The magnetoresistive spin-valve sensor as claimed in claim 15, wherein at least one of said first and second specular layers is made of a material selected from a group consisting of CoO, Co₃O₄, Co₂O₃, CU₂O, CuO, Al₂O₃, NiO, FeO, Fe₂O₃, Fe₃O₄, MnO, TiO₂, SiO₂, and alloys thereof.

17. The magnetoresistive spin-valve sensor as claimed in claim 15, wherein said first protection layer is made of a material selected from a group consisting of B, Ta, Ru, Ni, Fe, Pd, Pt, Mn, Cu, Co, Ti, C, Cr, Zn, Y, Zr, Nb, Mo, Rh, Ag, Au, Hf, W, Re, Os, Ir, Nb, alloys thereof, and oxides thereof.

18. The magnetoresistive spin-valve sensor as claimed in claim 17, wherein said first protection layer has a thickness greater than 0 and less than 20 Angstroms.

19. The magnetoresistive spin-valve sensor as claimed in claim 15, wherein said second specular layer and said second protection layer are formed by a single specular capping layer which is made of a material selected from a group consisting of CoO, Co₃O₄, Co₂O₃, Cu₂O, CuO, Al₂O₃, NiO, FeO, Fe₂O₃, Fe₃O₄, MnO, TiO₂, SiO₂, B, Ta, Ru, Ni, Fe, Pd, Pt, Mn, Cu, Co, Ti, C, Cr, Zn, Y, Zr, Nb, Mo, Rh, Ag, Au, Hf, W, Re, Os, Ir, Nb, alloys thereof, and oxides thereof.

20. The magnetoresistive spin-valve sensor as claimed in claim 19, wherein said single specular capping layer has a thickness greater than 0 and less than 200 Angstroms.

21. A magnetoresistive spin-valve sensor comprising:
a magnetic layer made of a magnetic layer forming a free layer;
a first specular layer disposed on said magnetic layer;
a first protection layer disposed on said first specular layer;
a second specular layer disposed on said first protection layer; and
a second protection layer disposed on said second specular layer.

22. The magnetoresistive spin-valve sensor as claimed in claim 21, wherein at least one of said first and second specular layers is made of a material selected from a group consisting of CoO, Co₃O₄, Co₂O₃, Cu₂O, CuO, Al₂O₃, NiO, FeO, Fe₂O₃, Fe₃O₄, MnO, TiO₂, SiO₂, and alloys thereof.

23. The magnetoresistive spin-valve sensor as claimed in claim 21, wherein said first protection layer is made of a material selected from a group consisting of B, Ta, Ru, Ni, Fe, Pd, Pt, Mn, Cu, Co, Ti, C, Cr, Zn, Y, Zr, Nb, Mo, Rh, Ag, Au, Hf, W, Re, Os, Ir, Nb, alloys thereof, and oxides thereof.

24. The magnetoresistive spin-valve sensor as claimed in claim 21, wherein said second specular layer and said second protection layer are formed by a single specular capping layer which is made of a material selected from a group consisting of CoO, Co₃O₄, Co₂O₃, Cu₂O, CuO, Al₂O₃, NiO, FeO, Fe₂O₃, Fe₃O₄, MnO, TiO₂, SiO₂, B, Ta, Ru, Ni, Fe, Pd, Pt, Mn, Cu, Co, Ti, C, Cr, Zn, Y, Zr, Nb, Mo, Rh, Ag, Au, Hf, W, Re, Os, Ir, Nb, alloys thereof, and oxides thereof.

25. A magnetoresistive spin-valve sensor comprising:
a spacer layer made of a metal material;
a magnetic layer disposed on said spacer layer and made of an amorphous material forming a free layer; and
a specular layer disposed on said magnetic layer.

26. A magnetic storage apparatus for reading information from a magnetic recording medium, comprising:
a magnetoresistive spin-valve sensor which reads the information from the magnetic recording medium,
said magnetoresistive spin-valve sensor comprising:
a first layer made of a magnetic material;
a second layer made of a magnetic or nonmagnetic material and disposed on said first layer; and
a third layer made of a magnetic material and disposed on said second layer,
said first, second and third layers forming a free layer having a multi-layer structure.

27. A magnetic storage apparatus for reading information from a magnetic recording medium, comprising:
a magnetoresistive spin-valve sensor which reads the information from the magnetic recording medium,
said magnetoresistive spin-valve sensor comprising:
a magnetic layer made of a magnetic material forming a free layer;
a first specular layer disposed on said magnetic layer;
a first protection layer disposed on said first specular layer;
a second specular layer disposed on said first protection layer; and
a second protection layer disposed on said second specular layer.

28. A magnetic storage apparatus for reading information from a magnetic recording medium, comprising:
a magnetoresistive spin-valve sensor which reads the information from the magnetic recording medium,
said magnetoresistive spin-valve sensor comprising:
a spacer layer made of a metal material;
a magnetic layer disposed on said spacer layer and made of an amorphous material forming a free layer; and
a specular layer disposed on said magnetic layer.
